(19) United States
(12) Patent Application Publication
(10) Pub. No.: US 2021/0345549 A1
(43) Pub. Date: Nov. 11, 2021

(54) Bracket System for Optional Sweeping Accessory for Lawn Mower and Method of Use Thereof

(71) Applicant: Frank Hwang, San Jose, CA (US)

(72) Inventor: Frank Hwang, San Jose, CA (US)

(21) Appl. No.: 17/307,926

(22) Filed: May 4, 2021

Related U.S. Application Data
(63) Continuation-in-part of application No. 16/872,249, filed on May 11, 2020.

(51) Int. Cl. A01D 42/06

(52) U.S. Cl. CPC A01D 42/06; A01D 2101/00

(57) ABSTRACT

A bracket system for attaching a brush to the blades of a rotary lawn mower. The bracket system has a brush attachment, at least one clamp, and a fastening device. The brush attachment has a brush, an elongated vertical slot, and a flange. The at least one clamp is placed around a non-linear lawn mower blade and is secured to the flange by the fastening device. Securing the clamp to the flange by the fastening device secures the brush attachment to the non-linear mower blade. Securing or removing the fastening device allows the attachment or removal of the brush attachment from the clamps, and thus the non-linear mower blade. In another embodiment, the bracket system includes a blade attachment configured to removably attach to the at least one clamp. The blade attachment is positioned on the opposite end of the non-linear lawn mower blade from the brush attachment.

### CROSS REFERENCE TO RELATED APPLICATIONS

This application is a continuation-in-part of U.S. patent application Ser. No. 16/872,249, filed May 11, 2020, which is incorporate by reference herein in its entirety.

### FIELD OF THE INVENTION

The present invention relates generally to a bracket system for attaching a brush to the blades of a rotary lawn mower.

### BACKGROUND OF THE INVENTION

Rotary lawn mowers are well known powered machines for cutting vegetation using a rotating blade or blades. Rotary lawn mowers use a horizontal blade or multiple horizontal blades which rotate around a central axis to cut vegetation, such as grass. The horizontal blades rotate parallel to the ground, and cut the vegetation to a uniform length.

When using a rotary lawn mower to cut vegetation, some additional objects may interfere with the cutting of the vegetation. For example, snow or leaves may need to be swept out of the way before the vegetation can be cut. To solve this, there is a need for a brush attachment to the blades of a rotary lawn mower to sweep away these objects that can interfere with the cutting of the vegetation. There also is a desire to add functionality to a lawn mower to permit it to be used to sweep surfaces such as driveways and sidewalks.

Brush attachments to rotary lawn mowers are known in the art. For example, United States Patent Number 3,048,869 to Beatty discloses a brush attachment for rotary mowers. Beatty discloses a brush attachment that is shaped like a separate blade, which is secured above the cutter blade. The brush attachment has two brushes at either end of the brush attachment, and is secured to the rotary mower by removing the cutter blade, inserting the brush attachment to the center bolt that holds the cutter blade, then replacing and securing the cutter blade. One significant issue with this attachment is that it is not easily removeable, which is a significant drawback when the user wants to switch back and forth between the sweeping and cutting functions. Additionally, the Beatty brush consumes greater resources because the attachment means utilizes an unnecessary amount of material to attach a small brush to the rotary mower.

There is a need for a brush attachment for a rotary lawn mower that is easily attachable and removable. Additionally, there is a need for a brush attachment that is compact in size and easy to use.

During experimentation and use of the brush attachment, it was discovered that the clamps used to attach the brush attachment to the blade of a rotary lawn mower blocked portions of the rotary lawn mower blade. The placement of the clamps, which are less sharp than the rotary lawn mower blade, interfered with the ability of the rotary lawn mower blade to cut vegetation uniformly, especially longer vegetation such as long grass. Therefore, there is also a need for a brush attachment that is easily attachable and removable, is compact and easy to use, and does not negatively affect the ability of the rotary lawn mower to cut vegetation, especially long vegetation, uniformly.

### SUMMARY OF THE INVENTION

The present invention relates to a bracket system for attaching a brush to the blades of a rotary lawn mower. It is an object of the invention to provide a bracket system that allows for the easy installation and removal of a brush to the blade of a lawn mower. It is another object of the invention to provide a bracket system for attaching a brush to the blades of a rotary lawn mower that is compact in size, and does not require the disassembling of the lawn mower blade to be attached. It is another object of the invention to provide a bracket system for attaching a brush to common non-linear mower blades readily available on the market without alteration to the blade.

The bracket system has a brush attachment. The brush attachment has a brush, an elongated vertical slot, and a flange. The bracket system also has at least one clamp and a fastening device. The at least one clamp is placed around a non-linear lawn mower blade and is secured to the flange by the fastening device. Securing the clamp to the flange by the fastening device secures the brush attachment to the non-linear mower blade. Securing or removing the fastening device allows the attachment or removal of the brush attachment from the clamps, and thus the non-linear mower blade.

In another embodiment, the bracket system has a brush attachment, at least one clamp, a fastening device, and a blade attachment. The brush attachment has a brush, an elongated vertical slot, and a flange. The at least one clamp has an aperture and a slot. The blade attachment has a blade body, a blade edge, and a tab. The blade attachment is secured to the clamp by inserting the tab of the blade attachment into the slot of the clamp.

The clamp is placed around a non-linear mower blade and secured to the flange of the brush attachment by the fastening device. Securing the clamp to the flange by the fastening device secures the brush attachment and blade attachment to the non-linear mower blade. Securing or removing the fastening device allows the attachment or removal of the brush attachment and blade attachment from the non-linear mower blade.

### BRIEF DESCRIPTION OF THE DRAWINGS

These and other features and advantages of the present invention will become appreciated, as the same becomes better understood with reference to the specification, claims and drawings herein:

FIG. 1 is a bottom view of a rotary lawn mower with a bracket system for attaching a brush to the blades of the rotary lawn mower secured to the mower blade according to a first embodiment.

FIG. 2 is a side view of a rotary lawn mower with the bracket system for attaching a brush to the blades of the rotary lawn mower secured to the mower blade according to a first embodiment.

FIG. 3 is a bottom perspective view of the bracket system for attaching a brush to the blades of a rotary lawn mower secured to a non-linear mower blade according to a first embodiment.

FIG. 4 is a side view of the bracket system for attaching a brush to the blades of a rotary lawn mower secured to the non-linear mower blade according to a first embodiment.

FIG. 5 is a bottom perspective view of the bracket system for attaching a brush to the blades of a rotary lawn mower detached from the non-linear mower blade according to a first embodiment.

FIG. 6 is a side view of the bracket system for attaching a brush to the blades of a rotary lawn mower secured to the non-linear mower blade according to a second embodiment.

FIG. 7 is a side view of the bracket system for attaching a brush to the blades of a rotary lawn mower secured to the non-linear mower blade according to a third embodiment.

FIG. 8 is a side view of the bracket system for attaching a brush to the blades of a rotary lawn mower secured to the non-linear mower blade according to a fourth embodiment.

FIG. 9 is a bottom perspective view of the bracket system with a blade attachment secured to the non-linear mower blade according to a fifth embodiment.

FIG. 10 is a side view of the bracket system with the blade attachment secured to the non-linear mower blade according to a fifth embodiment.

FIG. 11 is a bottom perspective view of the bracket system with the blade attachment detached from the non-linear mower blade according to a fifth embodiment.

FIG. 12 is a top perspective view of the blade attachment of the bracket system according to a fifth embodiment.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom,” and “upper” or “top,” and “inner” or “outer,” may be used herein to describe one element's relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

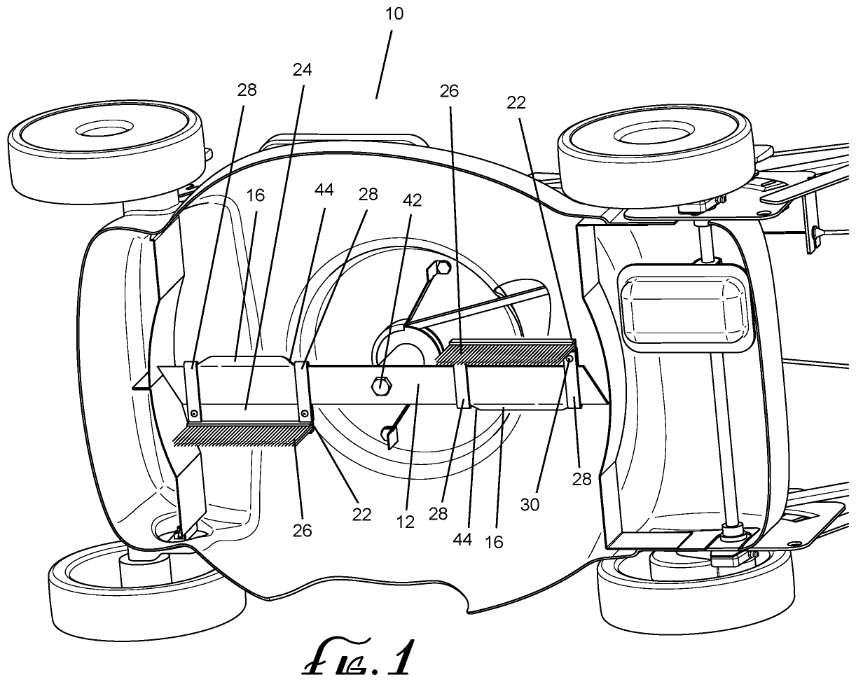

A bracket system for attaching a brush to the blade of a lawn mower is provided. FIGS. 1-5 depict the preferred embodiment of the bracket system 20 and how the bracket system 20 is removably secured to a non-linear mower blade 12 of a rotary lawn mower 10. A non-linear mower blade 12 is defined as a mower blade having an elongated edge in which a portion of said edge is defined by a protrusion, an indentation, and/or a projection out of the plane of the blade. As depicted in FIGS. 1-5, the bracket system 20 includes a brush attachment 21. The brush attachment 21 includes a brush 26, an elongated vertical slot 22, and a flange 24. The bracket system 20 also includes at least one clamp 28 and a fastening device. At least one clamp 28 surrounds a non-linear mower blade 12 and is secured to the brush attachment 21 by inserting the flange 24 into the at least one clamp 28 and securing the at least one clamp 28 to the flange 24. The flange 24 is fixed to the elongated vertical slot 22, which holds the brush 26. Attaching the at least one clamp 28 to the flange 24 of the brush attachment 21 secures the brush attachment 21 to the non-linear mower blade 12, thereby attaching the bracket system 20 to a rotary lawn mower 10.

In the preferred embodiment, the bracket system 20 is utilized to attach a brush attachment 21 to a non-linear mower blade 12. The brush attachment 21 includes the brush 26, elongated vertical slot 22, and the flange 24. The brush 26 extends downward from the elongated vertical slot 22, preferably to the surface of the ground. In the preferred embodiment, the brush 26 is made up of a plurality of bristles made of nylon. Alternate bristle materials may be utilized to make up the brush 26 without departing from the concepts disclosed herein.

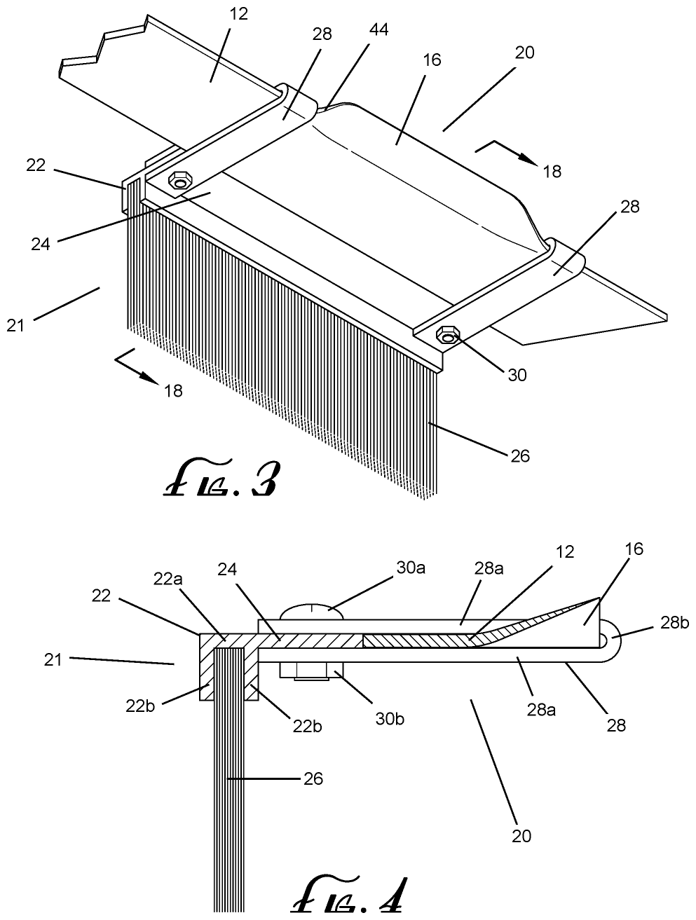

The elongated vertical slot 22 secures the brush 26 to the brush attachment 21. As shown in FIGS. 4-5, the elongated vertical slot 22 is characterized by an elongated horizontal base 22a with two vertical legs 22b extending downward from the elongated horizontal base 22a. The top portion of the brush 26 sits between the two vertical legs 22b of the elongated vertical slot 22 and is affixed to the elongated horizontal base 22a. The brush 26 is affixed to the elongated horizontal base 22a by attaching the bristles of the brush 26 to the elongated horizontal base 22a between the two vertical legs 22b. In other embodiments, the brush 26 is affixed to the elongated vertical slot 22 by crimping the two vertical legs 22b together. Alternatively, other ways of affixing the brush 26 to the elongated vertical slot 22 may be utilized without departing from the spirit of the invention.

Fixed to the elongated vertical slot 22 is a flange 24. In the preferred embodiment, the flange 24 extends from the elongated vertical slot 22 on the same plane as the elongated horizontal base 22a. But the flange 24 is not required to be in the same plane as the elongated horizontal base 22a, but rather the flange 24 could be secured to the elongated vertical slot 22 at different positions on one of the vertical legs 22b. The flange 24 may either be attached to the elongated vertical slot 22, or the flange 24 and elongated vertical slot 22 may be manufactured out of a single piece of material. The flange 24 is configured to be inserted and fit inside the clamp 28 when the brush attachment 21 is secured to the non-linear mower blade 12.

Preferably, the flange 24 includes at least one flange aperture 34. The at least one flange aperture 34 is configured to align with the clamp apertures 38 of the at least one clamp 28. The end of the flange 24 opposing the elongated vertical slot 22 is the same depth as the non-linear mower blade 12, such that the top and bottom of the flange 24 sits flush with the top and bottom of the non-linear mower blade 12 when the flange 24 contacts the non-linear mower blade 12. The flush top and bottom surface of the flange 24 and non-linear mower blade 12 provide a flat and flush surface to be inserted into the clamp 28.

The clamp 28 is configured to surround the non-linear mower blade 12 and secure the brush attachment 21 to the non-linear mower blade 12 by removably attaching to the flange 24. In the preferred embodiment shown in FIGS. 1-5, two clamps 28 are configured to surround the non-linear mower blade 12 and are secured to the flange 24 of the brush attachment 21 by a fastening device. While two clamps are used in the preferred embodiment, other embodiments may utilize a single clamp or a plurality of clamps.

The clamp 28 is generally c-shaped, characterized by two clamp legs 28a extending from a rounded base 28b. The length of each clamp leg 28a is greater than the width of the non-linear mower blade 12, such that when the clamp 28 is placed around a non-linear mower blade 12, a portion of each clamp leg 22a extends beyond the non-linear mower blade 12. The gap between each clamp leg 28a is greater than or equal to the depth of the non-linear mower blade 12 and the flange 24. Preferably the clamp 28 is made of a malleable material such that the gap between each clamp leg 28a may be greater than the depth of the non-linear mower blade 12 and the flange 24 when placing the clamp 28 around the non-linear mower blade 12, and equal to the depth of the non-linear mower blade 12 and the flange 24 when securing the clamp 28 to the non-linear mower blade 12.

While the preferred shape of the clamp 28 is disclosed in detail, other shapes may be used without departing from the spirit of the invention so long as the clamp sufficiently surrounds the non-linear mower blade 12.

Located in the portion of each clamp leg 22a that extends beyond the non-linear mower blade 12 is a clamp aperture 38. Each respective clamp leg 28a of each clamp 28 includes a clamp aperture 38. The clamp apertures 38 align with the flange aperture 34 when the flange 24 contacts the side of the non-linear mower blade 12 and the flange 24 and the non-linear mower blade 12 are inserted into the clamp 28. The alignment of the clamp apertures 38 and the flange aperture 34 allow a fastening device to secure the clamp 28 to the flange 24, thus securing the brush attachment 21 to the non-linear mower blade 12.

In the preferred embodiment, a bolt and nut 30 are utilized as the fastening device to secure the clamp 28 to the flange 24, thereby securing the brush attachment 21 to the non-linear mower blade 12. The bolt 30a is placed through the clamp apertures 38 and the flange aperture 34. The nut 30b is then screwed onto the bolt 30a, thereby securing the clamp 28 to the flange 24. While the preferred fastening device is a bolt and nut 30, other fastening devices may be utilized without departing from the spirit of the invention. For example, the second clamp aperture 38 may be threaded such that only a bolt 30a is needed to secure the clamp 28 to the flange 24. Alternatively, other methods of fastening the clamp 28 to the flange 24 without the need for the apertures are contemplated as well.

Tightening the bolt and nut 30 secures the clamp 28 to the flange 24 of the brush attachment 21, which thereby attaches the bracket system 20 to the non-linear mower blade 12. The bolt and nut 30 may be loosened and removed subsequently to remove the brush attachment 21 from the non-linear mower blade 12. Thus, the bracket system 20 is removeable from the non-linear mower blade 12 such that the brush attachment 21 may be easily attached to or removed from the rotary lawn mower 10.

FIG. 1 depicts the preferred embodiment of the bracket system 20 secured to a non-linear mower blade 12 of a rotary lawn mower 10, as shown from the bottom of the rotary lawn mower 10. In this embodiment, the bracket system 20 is attached to both portions of the non-linear mower blade 12 extending radially from the center point 42 of the non-linear mower blade 12. The bracket system 20 does not require modification to the non-linear mower blade 12, and is easily attached or removed as previously discussed. As shown in FIGS. 1 and 4, the non-linear mower blade 12 is characterized by a protrusion 16 extending outward and upward from the non-linear mower blade 12. This configuration of a non-linear mower blade 12 is utilized for exemplary purposes, as other configurations and shapes of non-linear mower blades may be utilized without departing from the concepts disclosed.

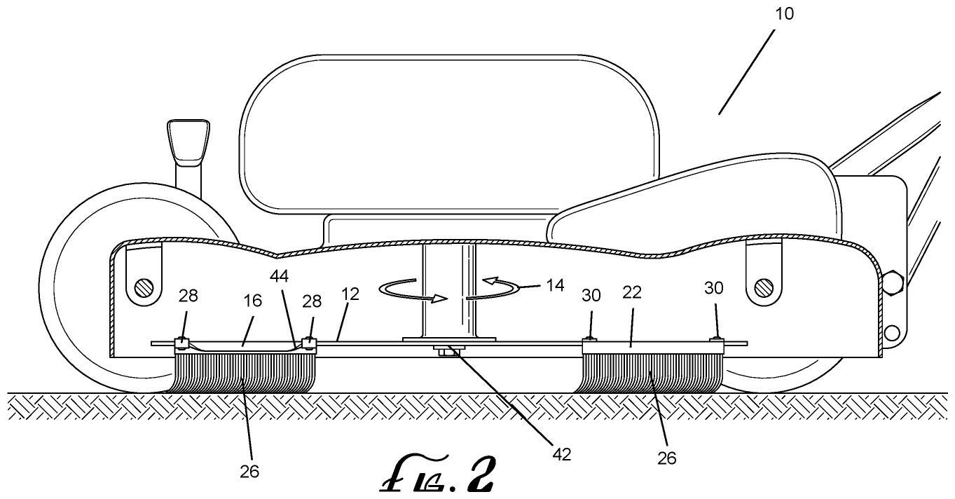

For the exemplary configuration of the non-linear mower blade 12, the bracket system 20 utilizes two clamps 28 which are positioned on each side of the protrusion 16. Each clamp 28 is secured to the flange 24 by the bolt and nut 30, thereby attaching the bracket system 20 to the non-linear mower blade 12. In the embodiment shown in FIGS. 2-3, the clamp 28 closest to the center point 42 of rotation of the blade 12 on the interior side of the protrusion 16 allows the clamp 28 to resist the centrifugal force 18 of the rotating blade 12. This is because the protrusion 16 provides a bracing surface 44 for the clamp 28 to brace against, thereby holding the bracket system 20 in place when the blade 12 rotates during operation of the lawn mower.

FIG. 2 depicts the preferred embodiment of the bracket system 20 secured to a non-linear mower blade 12 of a rotary lawn mower 10, as shown from the side of the rotary lawn mower 10. The rotation 14 of the non-linear mower blade 12 permits the brush 26 to contact and be moved across the ground while the bracket system 20 stays secured to the non-linear mower blade 12.

FIG. 3 depicts the preferred embodiment of the bracket system 20 secured to a non-linear mower blade 12, as viewed from the bottom perspective. The two clamps 28 are secured to the flange 24, thereby securing the brush attachment 21 to the non-linear mower blade 12. Each clamp 28 sits on one side of the protrusion 16 of the non-linear mower blade 12. When the non-linear mower blade 12 is rotating, the non-linear mower blade 12 and bracket system 20 undergo centrifugal forces 18. The protrusion 16 of the non-linear mower blade 12 prevents the bracket system 20 from sliding off the non-linear mower blade 20 due to the centrifugal forces 18.

While this configuration of a non-linear mower blade 12 with the protrusion 16 is used for exemplary purposes, other configurations of non-linear mower blades may be utilized so long as at least one clamp 28 is positioned such that at least one clamp 28 sits adjacent to the non-linear portion of a non-linear mower blade 12. For example, a blade 12 could be used that has an indentation along its edge. The clamps 28 can be secured within the indentation in order to provide a bracing surface 44 for at least one of the clamps 28 to resist the centrifugal force 18 caused by the rotation 14 of the non-linear mower blade 12.

FIG. 4 depicts the preferred embodiment of the bracket system 20 secured to a non-linear mower blade 12, as viewed from the side. The protrusion 16 of the non-linear mower blade 12 extends outward and upward from the non-linear mower blade 12, such that the clamp 28 cannot slide off the non-linear mower blade 12 under centrifugal forces 18. The clamp 28 surrounds the non-linear mower blade 12 adjacent to the protrusion 16 and is attached to the flange 24 by the bolt 30a and nut 30b. The brush attachment 21 is therefore removably secured to the non-linear mower blade 12.

FIG. 5 depicts the preferred embodiment of the bracket system 20 detached from the non-linear mower blade 12, as viewed from the bottom perspective. In the preferred embodiment, the brush attachment 21 is separated from the clamps 28 and fastening device. The elongated vertical slot 22 and flange 24 are constructed out of a single piece of material, with the brush 26 secured inside the elongated vertical slot 22.

The bracket system 20 includes two clamps 28 which are capable of being secured to the flange 24 through the bolt 30a and nut 30b which are placed through the clamp apertures 38 and the flange aperture 34. When the bracket system 20 is not attached to the non-linear mower blade 12, each of the two clamps 28, and the bolts 30a and nuts 30b, and the brush attachment 21 are separate pieces.

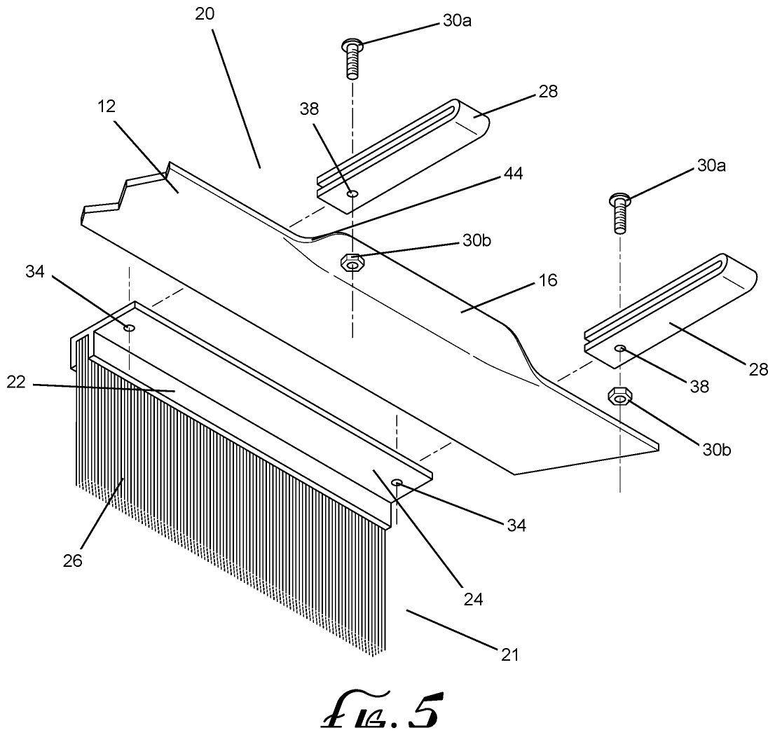

An alternate embodiment of securing the brush attachment 21 to the clamp 28, thereby attaching the bracket system 20 to the non-linear mower blade 12, is shown in FIG. 6. In this alternate embodiment, the flange 24 is configured to overlap the non-linear mower blade 12 when the bracket system 20 is attached to the non-linear mower blade 12. The flange aperture is positioned closer to the elongated vertical slot 22 than the opposing end of the flange 24. The flange aperture is located on the portion of the flange 24 that does not overlap the non-linear mower blade 12. The clamp apertures are positioned near the end of the clamp 28. The location of the flange aperture and clamp apertures are configured to align and permit a bolt 30a to be placed through the clamp apertures and flange apertures without being placed through the non-linear mower blade 12. When the bolt 30a is placed through the clamp apertures and flange aperture, the non-linear mower blade 12 abuts the bolt 30a. Tightening the nut 30b onto the bolt 30a removably secures the flange 24 to the clamp 28, thereby removably attaching the bracket system 20 to the non-linear mower blade 12.

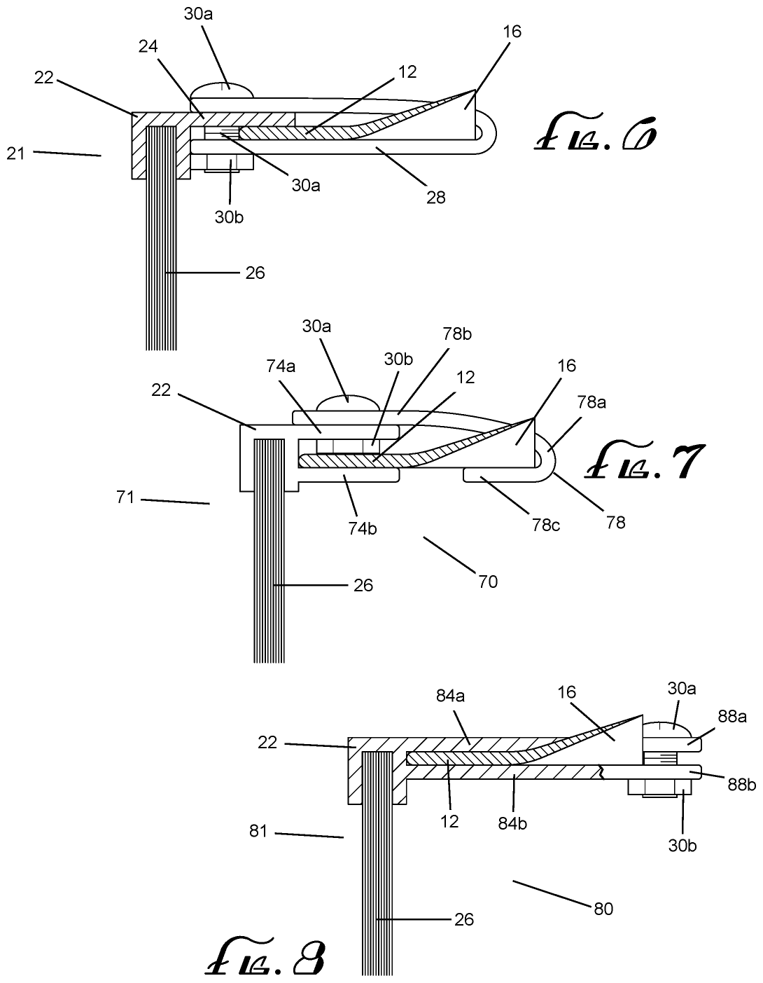

FIGS. 7 and 8 depict additional alternate embodiments of the bracket system 20 wherein the brush attachment has more than one flange to secure the brush attachment to the non-linear mower blade 12. The concept of positioning at least one clamp in a location on the non-linear mower blade 12 such that at least one clamp sits adjacent to the non-linear portion of a non-linear mower blade 12 in order to provide a bracing surface for at least one of the clamps to resist the centrifugal force 18 caused by the rotation 14 of the non-linear mower blade 12 remains constant throughout each alternate embodiment. Thus, each alternate embodiment provided in FIGS. 6-8 illustrate an alternate way of removably attaching a bracket system to a non-linear mower blade 12 in the same location as the preferred embodiment.

FIG. 7 depicts a bracket system 70 including a brush attachment 71, hook clamp 78, and fastening device. The brush attachment 71 includes an elongated vertical slot 22, brush 26, top flange 74a, and bottom flange 74b. The top flange 74a and the bottom flange 74b may either be attached to the elongated vertical slot 22, or the top flange 74a, bottom flange 74b, and elongated vertical slot 22 may be manufactured out of a single piece of material. The hook shape of the hook clamp 78 is defined as a piece of material with a curved portion 78a with a first leg portion 78b and second leg portion 78c extending from the curved portion 78a, where the first leg portion 78b is greater in length than the second leg portion 78c. The hook clamp 78 includes a hook clamp aperture located at the end of the first leg portion 78b. The top flange 74a includes a flange aperture configured to align with the hook clamp aperture and receive the fastening device. The non-linear mower blade 12 is inserted into the gap between the top flange 74a and the bottom flange 74b, and the hook clamp 78 is positioned around the non-linear mower blade 12 such that the second leg portion 78c sits below the non-linear mower blade 12. The gap between the top flange 74a and bottom flange 74b is large enough to accept a non-linear mower blade 12 and at least a portion of the fastening device.

In the alternate embodiment depicted in FIG. 7, the fastening device is a bolt 30a and nut 30b. The bolt 30a is placed through the hook clamp aperture and top flange aperture, and the nut 30b tightens onto the bolt 30a, thereby removably securing the top flange 74a of the brush attachment 71 to the hook clamp 78. The gap between the top flange 74a and the bottom flange 74b is large enough for the nut 30b and the non-linear mower blade 12 to fit inside, while being small enough so when the nut 30b is tightened to the bolt 30a, the non-linear mower blade 12 is securely held between the top flange 74a and bottom flange 74b. Thus, when the hook clamp 78 is positioned around the non-linear mower blade 12 and the hook clamp is secured to the top flange 74a of the brush attachment 71 by the bolt 30a and nut 30b, the bracket system 70 is removably attached to the non-linear mower blade 12.

FIG. 8 depicts a bracket system 80 including a brush attachment 81 and fastening device. The brush attachment 81 includes an elongated vertical slot 22, brush 26, top flange 84a, bottom flange 84b, top flange clamp 88a, and bottom flange clamp 88b.

The top flange 84a and the bottom flange 84b may either be attached to the elongated vertical slot 22, or the top flange 84a, bottom flange 84b, and elongated vertical slot 22 may be manufactured out of a single piece of material. The top flange 84a and top flange clamp 88a are preferably flush together, and may either be constructed of a single piece of material, or the top flange clamp 88a may be attached to the top flange 84a. Similarly, the bottom flange 84b and bottom flange clamp 88b are preferably flush together, and may either be constructed of a single piece of material, or the bottom flange clamp 88b may be attached to the bottom flange 84b. The gap between the top flange 84a and top flange clamp 88a, and the bottom flange 84b and bottom flange clamp 88b, is configured to allow the insertion of the non-linear mower blade 12.

The length of the top flange 84a and top flange clamp 88a is greater than the width of the non-linear mower blade 12. Similarly, the length of the bottom flange 84b and bottom flange clamp 88b is greater than the width of the non-linear mower blade 12.

The portion of the top flange clamp 88a that extends beyond the inserted non-linear mower blade 12 includes a top aperture. Likewise, the portion of the bottom flange clamp 88b that extends beyond the inserted non-linear mower blade 12 includes a bottom aperture. The top aperture and bottom aperture are configured to be aligned and receive the fastening device.

The preferred fastening device for the alternate embodiment depicted by FIG. 8 is a bolt 30a and nut 30b. The bolt 30a is placed through the top aperture and bottom aperture, and the nut 30b is then tightened onto the bolt 30a. The top aperture and bottom aperture are positioned such that the bolt 30a may be inserted through the top aperture and bottom aperture without being placed through the non-linear mower blade 12.

The nut 30b is tightened onto the bolt 30a, thereby removably securing the brush attachment 81 to the non-linear mower blade 12. Thus, the bracket system 80 is removably attached to the non-linear mower blade 12.

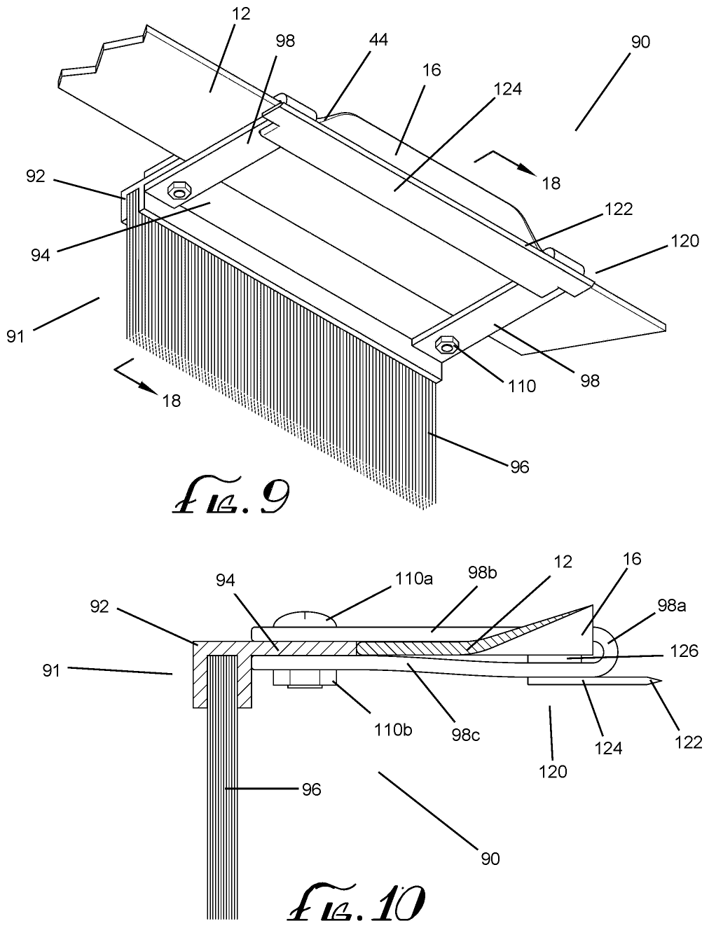

FIGS. 9-12 depict an alternative embodiment of the bracket system 90 that includes a blade attachment 120. The blade attachment 120 is the preferred solution for the negative affect of the bracket system 90 in cutting vegetation uniformly, especially longer vegetation and grasses. This solution is due to the blade attachment 120 providing an additional blade edge 122 that is configured to provide a cutting edge in the location where the clamps of the bracket system are mounted. Additionally, the blade attachment 120 provides another cutting edge beyond that of the non-linear mower blade 12 to improve the ability of the non-linear mower blade 12 to cut and facilitate the uniform cutting of vegetation, especially longer grasses. Additionally, the placement of the blade attachment 120 keeps the brush attachment 91 cleaner while cutting vegetation in general, as the additional blade edge 122 accompanied by the centrifugal force 18 caused by the rotation clears cut grass from the path of the brush 96 of the brush attachment 91.

In embodiments that do not utilize the blade attachment 120, a similar solution to the blade attachment solution may be accomplished by sharpening the rounded base 28b of the at least one clamp 28 to a sharpened edge. In these embodiments, the sharpened edge of the rounded base 28b provides a cutting edge in place of the non-linear mower blade 12 edge that is covered by the at least one clamp 28. While a sharpened rounded base 28b will provide a similar effect without departing from the concepts disclosed herein, the blade attachment 120 and method of attaching said blade attachment 120 is preferred. This is because the blade attachment 120 provides an additional blade edge 122 beyond that of only the non-linear mower blade 12, thereby further improving the ability of the rotary lawn mower 10 to cut vegetation uniformly while the bracket system 90 is attached to the non-linear mower blade 12. It is further contemplated that some other embodiments may utilize both a sharpened edge of the rounded base 98a and the blade attachment 120 together without departing from the concepts disclosed herein.

As shown in FIGS. 9-12, the bracket system 90 includes a brush attachment 91, at least one slotted clamp 98, a fastening device, and the blade attachment 120. As with the embodiment shown in FIGS. 1-5, the brush attachment 91 in this alternative embodiment includes an elongated vertical slot 92, a flange 94, a flange aperture 104, and the brush 96. As this alternative embodiment utilizes the same brush attachment configuration 91 as the embodiment shown in FIGS. 1-5, please refer to the concepts disclosed in paragraphs [0032] to [0034] for reference to the configuration of the brush attachment 91. It is also noted that while this alternative embodiment utilizes the same brush attachment 91 as the brush attachment 21 disclosed in FIGS. 1-5, the concepts disclosed herein with respect to the blade attachment 120 itself and the method of attaching the blade attachment 120 to the non-linear mower blade 12 may similarly be used with the alternate embodiments of the brush attachment shown in FIGS. 6-8. Additionally, while the same non-linear mower blade 12 is used in this alternative embodiment as well, this non-linear mower blade 12 is also used solely for exemplary purposes, as the bracket system 90 having the blade attachment 120 may be used on any non-linear mower blade 12 as described above.

Similar to the embodiment disclosed in FIGS. 1-5, the slotted clamp 98 shown in FIGS. 9-12 is configured to surround the non-linear mower blade 12 and secure the brush attachment 91 to the non-linear mower blade 12 by removably attaching to the flange 94. In the alternative embodiment shown in FIGS. 9-12, two clamps 98 are configured to surround the non-linear mower blade 12 and are secured to the flange 94 of the brush attachment 91 by a fastening device. While two clamps are used in this alternative embodiment, other embodiments may utilize a single clamp or a plurality of clamps without departing from the concepts disclosed herein.

The slotted clamp 98 is also generally c-shaped, characterized by a top slotted clamp leg 98b and a bottom slotted clamp leg 98c extending from a rounded base 98a. The length of the top slotted clamp leg 98b and the bottom slotted clamp leg 98c is greater than the width of the non-linear mower blade 12, such that when the slotted clamp 98 is placed around a non-linear mower blade 12, a portion of the top slotted clamp leg 98b and the bottom slotted clamp leg 98c extend beyond the non-linear mower blade 12. The gap between the top slotted clamp leg 98b and the bottom slotted clamp leg 98c is greater than or equal to the depth of the non-linear mower blade 12 and the flange 94.

As with previous embodiments, the slotted clamp 98 is preferably made of a malleable material. The malleable material permits the gap between the top slotted clamp leg 98b and the bottom slotted clamp leg 98c to be greater than the depth of the non-linear mower blade 12 and the flange 94 when placing the slotted clamp 98 around the non-linear mower blade 12, and equal to the depth of the non-linear mower blade 12 and the flange 24 when securing the slotted clamp 98 to the non-linear mower blade 12. While the preferred c-shape of the slotted clamp 98 is disclosed in detail, other shapes may be used without departing from the spirit of the invention so long as the clamp sufficiently surrounds the non-linear mower blade 12.

Located in the portion of the top slotted clamp leg 98b and the bottom slotted clamp leg 98c that extend beyond the non-linear mower blade 12 is a slotted clamp aperture 108. Each of the at least one slotted clamp 98 includes a slotted clamp aperture 108. The slotted clamp apertures 108 align with the flange aperture 104 when the flange 94 contacts the side of the non-linear mower blade 12 and the flange 94 and the non-linear mower blade 12 are inserted into the slotted clamp 98. Each of the slotted clamps 98 further include a slot 106 placed on the bottom slotted clamp leg 98c proximate to the rounded base 98a. While the slot is preferably located on the bottom slotted clamp leg 98c, the slot 106 may also be placed on the top slotted clamp leg 98b without departing from the concepts disclosed herein. The slot 106 is configured such that the tab 126 of the blade attachment 120 may be inserted into the slot 106, thereby securing the blade attachment 120 to the slotted clamps 98. Therefore, the alignment of the slotted clamp apertures 108 and the flange aperture 104 allow a fastening device to secure the slotted clamp 98 to the flange 94, thus securing the brush attachment 91 and the blade attachment 120 to the non-linear mower blade 12.

Importantly, the slotted clamp 98 in this alternative embodiment may be utilized with any prior embodiment utilizing a clamp. For example, the slotted clamp 98 may be used instead of the clamp 28 in the embodiment depicted in FIGS. 1-5, as the presence of the slot 106 in the slotted clamp 98 does not affect the ability of the slotted clamp 98 to surround the non-linear mower blade 12 and secure the bracket system 90 to the non-linear mower blade 12. Furthermore, a slot 106 may be placed into second leg 78c of the hook clamp 78 depicted in FIG. 7, thereby creating a slot in the hook clamp 78 that the blade attachment 120 may be inserted into. Through this general slot feature as described, the blade attachment 120 may be attached to any embodiment of the invention utilizing a clamp without departing from the concepts disclosed.

The blade attachment 120, shown apart from the bracket system 90 in FIG. 12, includes a blade edge 122, a blade body 124, and at least one tab 126. As discussed above, the tab 126 of the blade attachment 120 is configured to be inserted into the slot 106 of the slotted clamp 98, such that blade attachment 120 is removably attached to the slotted clamp 98. Preferably, the tab 126 should tightly fit into the slot 106, such that once the tab 126 is inserted into the slot 106, the blade attachment 120 will not be removed from slotted clamps 98 without an external force pulling the tab 126 back out of the slot 106.

As with the embodiment depicted in FIGS. 1-5, a bolt and nut 110 are utilized as the fastening device to secure the slotted clamp 98 to the flange 94, thereby securing the brush attachment 91 to the non-linear mower blade 12. The bolt 110a is placed through the slotted clamp apertures 108 and the flange aperture 94. The nut 110b is then screwed onto the bolt 110a, thereby securing the slotted clamp 98 to the flange 94. While the preferred fastening device for this alternative embodiment is a bolt and nut 110, other fastening devices may be utilized without departing from the spirit of the invention.

The preferred configuration of this alternative embodiment of the bracket system 90 having the blade attachment 120 as shown in FIGS. 9-12 is further disclosed.

FIG. 9 depicts a bottom perspective view of this preferred configuration attached to the non-linear mower blade 12. In this preferred configuration, the bracket system 90 is configured to removably attach to the non-linear mower blade 12 through two slotted clamps 98. The two slotted clamps 98 are secured to the flange 94, thereby securing the brush attachment 91 to the non-linear mower blade 12. Each slotted clamp 98 sits on one side of the protrusion 16 of the non-linear mower blade 12. When the non-linear mower blade 12 is rotating, the non-linear mower blade 12 and bracket system 20 undergo centrifugal forces 18. The centrifugal forces 18 cause one of the two slotted clamps 98 to abut the bracing surface 44 of the protrusion 16 of the non-linear mower blade 12, thereby preventing the bracket system 20 from sliding off the non-linear mower blade 20 due to the centrifugal forces 18.

The blade attachment 120 is configured to be attached to each of the slotted clamps 98. The blade body 124 and blade edge 122 thereby span the distance between the two slotted clamps 98, as well as the length of the protrusion 16. While the length of the blade attachment 120 is shown for exemplary purposes, blades of other sizes may be used without departing from the concepts disclosed. Therefore, when the bracket system 90 is attached to the non-linear mower blade 12, the blade attachment 120 will be located on the opposing side of the non-linear mower blade 12 from the brush attachment 91.

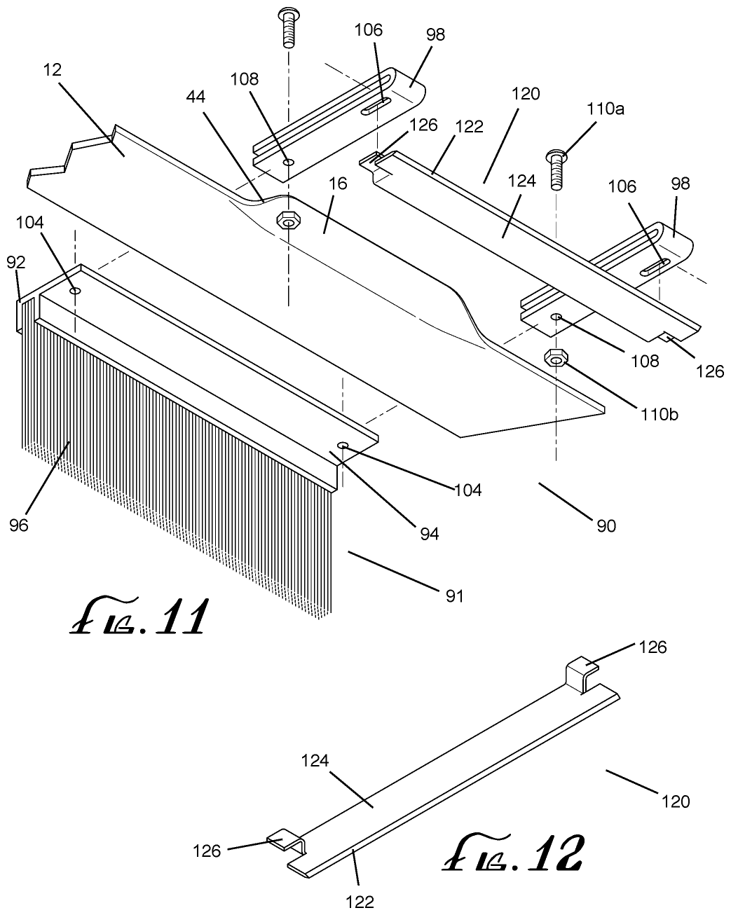

FIG. 10 provides the side view of the preferred configuration of this bracket system 90 having a blade attachment 120 attached to the non-linear mower blade. As with prior embodiments, the protrusion 16 of the non-linear mower blade 12 extends outward and upward from the non-linear mower blade 12, such that the slotted clamp 98 cannot slide off the non-linear mower blade 12 under centrifugal forces 18. The slotted clamp 98 surrounds the non-linear mower blade 12 adjacent to the protrusion 16 and is attached to the flange 94 by the bolt 110a and nut 110b. The blade attachment 120 is configured to be attached to the slot 106 of the slotted clamp 98 by inserting the tab 126 into the slot 106 as previously described. Once the blade attachment 120 is attached to the slotted clamps 98, the bracket system 90 is secured to the non-linear mower blade 12 as described with respect to FIG. 11 below. Thus, the brush attachment 91 and blade attachment 120 are removably secured to the non-linear mower blade 12.

Once the tab 126 is inserted into the slot 106, the tab 126 sits on the opposing side of the slotted clamp 98 from the blade body 124 and blade edge 122. The tab 126 is located in between the non-linear mower blade 12 and the slotted clamp 98, such that when the bracket system 90 is secured to the non-linear mower blade 12, the blade attachment 120 is fixed in place through the pressure caused by tightening the slotted clamp 98 with the bolt and nut 110. Importantly, the blade edge 122 extends beyond the rounded base 98a of the slotted clamp 98. Thus, the blade edge 122 is capable of cutting vegetation, especially longer vegetation and long grasses, uniformly.

As shown in the preferred configuration depicted in FIG. 12, the blade attachment 120 include two tabs 126, one on each end of the blade body 124. The tab 126 is an l-shaped portion of the blade body 124 that extends first upward from then parallel to the blade body 124, creating the l-shape. Each tab 126 is configured to be inserted into each slot 106 of the slotted clamps 98. While the preferred configuration depicted by FIGS. 9-12 include two slotted clamps 98 and two tabs 126, other embodiments may use one clamp and one tab, or more than two clamps and more than two tabs to secure the blade attachment 120 to the bracket system 90 without departing from the concepts disclosed herein.

FIG. 11 depicts the preferred configuration of the bracket system 90 having the blade attachment 120 detached from the non-linear mower blade 12, as viewed from the bottom perspective. When the bracket system 90 is not attached to the non-linear mower blade 12, each of the two slotted clamps 98, and the bolts 110a and nuts 110b, the brush attachment 91, and the blade attachment 120 are separate pieces.

As shown in FIG. 11, the method of attaching the bracket system 90 to the non-linear mower blade 12 is similar to the embodiment depicted in FIGS. 1-5. First, the blade attachment 120 is secured to the slotted clamps 98. This step is done by inserting each of the two tabs 126 of the blade attachment 120 into each slot 106 of each slotted clamp 98. Once this step is complete, the bracket system 90 will be made up of three separate pieces, namely, the brush attachment 91, the fastening device (bolt and nut 110 here), and the slotted clamps 98 with the blade attachment 120 attached.

Next, the slotted clamps 98 with the blade attachment 120 attached are positioned about the non-linear mower blade 12 such that each slotted clamp 98 is positioned on each side of the protrusion 16. This permits the slotted clamp 98 to engage the bracing surface 44 of the protrusion 16.

Once the slotted clamps 98 with the blade attachment 120 are positioned around the non-linear mower blade 12, the brush attachment 91 is placed adjacent to the non-linear mower blade 12 such that the flat edge of the flange 94 aligns with the flat edge of the non-linear mower blade 12. Then, the slotted clamp apertures 108, which extend beyond the end of the non-linear mower blade 12, are aligned with the flange apertures 104. Lastly, the fastening device, or here the bolt 110a and nut 110b, fastens the slotted clamps 98 to the flange 94 of the brush attachment 91. To perform this fastening in the preferred configuration depicted in FIG. 11, each bolt 110a is inserted through each slotted clamp aperture 108 on each top slotted clamp leg 98b, then through each flange aperture 104, then through each slotted clamp aperture 108 on each bottom slotted clamp leg 98c. A portion of the bolt 110a will extend beyond the apertures 104 & 108 such that the nut 110b may be screwed onto the bolt 110a, thereby fastening the brush attachment 91 to the slotted clamps 98. Once the nut 110b is tightened, the bracket system 90 is attached to the non-linear mower blade 12. Performing these steps in the opposite manner will remove the bracket system 90 from the non-linear mower blade 12.

It should be noted that the method disclosed for this embodiment is essentially the same as previous embodiments absent the step of securing the blade attachment 120 to the slotted clamps 98. Therefore, regardless of the specific embodiment, the attaching and removing of the bracket system 90 from the non-linear mower blade 12 is easily performed as described above. This ease of attaching and removing the bracket system 90 from the non-linear mower blade 12 is important, as adding the blade attachment 120 does not affect the ease of attaching or removing the bracket system 90 to the non-linear mower blade 12. The only difference between the method of attaching bracket system 20 embodiment depicted in FIGS. 1-5 and the bracket system 90 embodiment depicted in FIGS. 9-12 is first attaching the blade attachment 120 to the slotted clamps 98 in the bracket system 90 embodiment having the blade attachment 120.

While the invention has been described in terms of a preferred embodiment, it is to be understood that the words that have been used are words of description and not of limitation. As is understood to persons of ordinary skill in the art, a variety of modifications can be made without departing from the scope of the invention defined by the following claims, which should be given their fullest, fair scope.

I claim,

1. A bracket system to be removably attached to a non-linear lawn mower blade, the bracket system comprising:
a brush attachment;
a blade attachment;
at least one clamp; and
a fastening device;
wherein said blade attachment is removably attached to said at least one clamp;
wherein said at least one clamp is configured to surround said non-linear lawn mower blade; and
wherein said brush attachment is removably attached to said at least one clamp by said fastening device.

2. The bracket system of claim 1, wherein said fastening device is a bolt and nut.

3. The bracket system of claim 1, wherein said at least one clamp includes a gap, wherein said gap is greater than or equal to the depth of said non-linear lawn mower blade.

4. The bracket system of claim 1, wherein said brush attachment comprises a brush, an elongated vertical slot, and a flange.

5. The bracket system of claim 4, wherein said flange and said non-linear lawn mower blade are configured to be inserted into said at least one clamp.

6. The bracket system of claim 4, wherein said flange has a flange depth, wherein said non-linear lawn mower blade has a blade depth, and wherein said flange depth is equal to said blade depth.

7. The bracket system of claim 4, wherein said brush is made of nylon.

8. The bracket system of claim 4, wherein said elongated vertical slot and said flange are constructed of a single piece of material.

9. The bracket system of claim 1, wherein said blade attachment comprises a blade body, a blade edge, and at least one blade tab.

10. The bracket system of claim 9, wherein said at least one clamp includes at least one clamp slot.

11. The bracket system of claim 10, wherein said at least one blade tab is configured to be inserted into at least one clamp slot.

12. A bracket system for connecting a brush attachment and a blade attachment to a non-linear lawn mower blade having a bracing surface, the bracket system comprising:
a brush;
a brush attachment having an elongated vertical slot for receiving said brush;
a flange secured to said elongated vertical slot, said flange having at least one flange aperture;
at least one clamp, wherein said at least one clamp has a clamp aperture and a slot;
a blade attachment having a blade body, a blade edge, and a tab; and
at least one fastening device;
wherein said tab of said blade attachment is configured to be inserted into said slot of said at least one clamp;
wherein said clamp aperture and said flange aperture are configured to be aligned;
wherein said at least one fastening device is configured to pass through said clamp aperture and said flange aperture; and
wherein said at least one clamp removably fastens to said flange about said non-linear blade of a lawn mower in a position in which said clamp can engage said bracing surface of said non-linear blade of a lawn mower.

13. A method of removably attaching a bracket system having a blade attachment, a brush attachment, at least one clamp, and a fastening device to a non-linear lawn mower blade having a bracing surface, the improved method comprising:
attaching said blade attachment to said at least one clamp, wherein said at least one clamp has at least one aperture at each end of said at least one clamp;
positioning said at least one clamp around said non-linear lawn mower blade, wherein a portion of said at least one clamp having said at least one aperture extends beyond the non-linear lawn mower blade, and wherein said at least one clamp is proximate to said bracing surface;
positioning said brush attachment adjacent to said non-linear lawn mower blade, wherein said brush attachment comprises a brush, an elongated vertical slot, and a flange having at least one aperture;
inserting said flange into said at least one clamp;
aligning said aperture of said flange with said aperture of said at least one clamp; and
fastening said at least one clamp to said flange with a fastening device placed through said apertures.

14. The improved method of claim 13, further comprising:
loosening said fastening device placed through said apertures; and
removing said at least one clamp from said flange, and
removing said bracket system from said non-linear lawn mower blade.

15. The improved method of claim 13, wherein said fastening device is a bolt and nut.

16. The improved method of claim 13, wherein said blade attachment comprises a blade body, a blade edge, and at least one blade tab, wherein said at least one blade tab is located at the opposite end of said blade body from said blade edge, and wherein said at least one clamp further comprises a slot.

17. The improved method of claim 16, wherein attaching said blade attachment to said at least one clamp comprises:
inserting said at least one blade tab into said slot of said at least one clamp.

18. The improved method of claim 16, wherein said fastening device is a bolt and nut.

19. The improved method of claim 13, wherein said at least one clamp is c-shaped.

20. The improved method of claim 19, wherein said at least one c-shaped clamp has a gap, wherein said gap is greater than or equal to the depth of said non-linear lawn mower blade and said flange.
